(19) United States
(12) Patent Application Publication
(10) Pub. No.: US 2024/0369787 A1
(43) Pub. Date: Nov. 7, 2024

(54) OPTICAL CONNECTION STRUCTURE

(71) Applicant: Fujikura Ltd., Tokyo (JP)

(72) Inventor: Masayuki Hirose, Sakura-shi (JP)

(73) Assignee: Fujikura Ltd., Tokyo (JP)

(21) Appl. No.: 18/689,244

(22) PCT Filed: Apr. 15, 2022
(86) PCT No.: PCT/JP2022/017941

§ 371 Date: Mar. 5, 2024

(30) Foreign Application Priority Data
Sep. 14, 2021 (JP) 2021-149053

(51) Int. Cl. G02B 6/42

(52) U.S. Cl. CPC G02B 6/4292; G02B 6/4228

(57) ABSTRACT

An optical connection structure includes a substrate, an optical integrated circuit, including a reception/emission portion that receives and emits an optical signal, that is electrically connected to the substrate, a microlens array including a first lens disposed at a position corresponding to the reception/emission portion, a ferrule including a fiber hole into which an optical fiber is inserted and a second lens into which an optical signal from the optical fiber is input, and a receptacle that holds the ferrule. The optical integrated circuit and the receptacle are fixed to the microlens array. The second lens faces the first lens when the receptacle holds the ferrule.

### CROSS-REFERENCE TO RELATED APPLICATIONS

The present application claims priority to Japanese Patent Application No. 2021-149053, filed Sep. 14, 2021. The contents of this application are incorporated herein by reference in their entirety.

### BACKGROUND

### Technical Field

The present invention relates to an optical connection structure.

### Description of the Related Art

Patent Document 1 discloses an optical connection structure that includes a substrate, an optical integrated circuit, and a ferrule through which an optical fiber is inserted.

### PATENT DOCUMENT

Patent Document 1: United States Patent Publication No. 2021/0055489

Conventionally, for the purpose of an increase in speed of data communication, a technology in which a plurality of electronic substrates are connected with an optical fiber has been used. In order to further increase a speed of data communication, a connection method (so-called butt joint) in which an optical fiber is brought into contact with and directly connected to an optical integrated circuit (PIC: Photonic Integrated Circuit) mounted on an electronic substrate has attracted attention (for example, see Patent Document 1).

Incidentally, in a connection method using the butt joint, a pressing force of about 1 to 2 kgf is generally required so that the optical fiber and the optical integrated circuit are made to abut each other. However, since an optical integrated circuit is a precision component, there are cases in which it does not withstand such a high pressing force as described above.

### SUMMARY

One or more embodiments provide an optical connection structure capable of reducing a load on an optical integrated circuit.

An optical connection structure according to one or more embodiments includes a substrate, an optical integrated circuit which is electrically connected to the substrate and includes a reception/emission portion receiving and emitting an optical signal, a microlens array which includes a first lens disposed at a position corresponding to the reception/emission portion, a ferrule which includes a second lens, and a fiber hole into which an optical fiber inputting an optical signal into the second lens is insertable, and a receptacle which holds the ferrule, in which the optical integrated circuit and the receptacle are fixed to the microlens array, and the second lens faces the first lens when the receptacle holds the ferrule.

According to one or more embodiments, it is possible to provide an optical connection structure capable of reducing a load on an optical integrated circuit.

### BRIEF DESCRIPTION OF THE DRAWINGS

FIG. 1 is a perspective view illustrating the entire optical connection structure according to a first example.

FIG. 2 is an enlarged view of an optical connection unit illustrated in FIG. 1.

FIG. 3 is a view of the optical connection unit illustrated in FIG. 2 from the arrow III.

FIG. 4 is an enlarged view of a region illustrated in FIG. 3.

FIG. 5 is a view of a microlens array illustrated in FIG. 3 from the arrow V.

FIG. 6 is a cross-sectional view taken along line VI-VI indicated by the arrow illustrated in FIG. 3.

FIG. 7 is a view of a ferrule illustrated in FIG. 3 from the arrow VII.

FIG. 8 is a view of the ferrule illustrated in FIG. 7 from the arrow VIII.

FIG. 9 is a view illustrating a method of positioning the microlens array according to the first example.

FIG. 10A is a view illustrating an attachment method of the ferrule according to the first example.

FIG. 10B is a view illustrating a state following FIG. 10A.

FIG. 11 is a diagram illustrating an operation of the optical connection structure according to the first example.

FIG. 12 is a perspective view illustrating an optical connection structure according to a second example.

FIG. 13 is a view illustrating a method of positioning a microlens array according to the second example.

FIG. 14 is a view illustrating an attachment method of a ferrule according to the second example.

FIG. 15 is a cross-sectional view taken along line XV-XV indicated by the arrow illustrated in FIG. 12.

FIG. 16 is a perspective view illustrating an optical connection structure according to a third example.

FIG. 17 is a view illustrating an attachment method of a ferrule according to the third example.

FIG. 18 is a view illustrating a method of positioning a microlens array according to the third example.

FIG. 19 is a cross-sectional view along line XIX-XIX indicated by the arrow illustrated in FIG. 16.

FIG. 20 is a perspective view illustrating an optical connection structure according to a fourth example.

FIG. 21 is a view illustrating an attachment method of a ferrule according to the fourth example.

FIG. 22 is a view illustrating a method of positioning a microlens array according to the fourth example.

FIG. 23 is a view of the optical connection structure illustrated in FIG. 20 from the arrow XXIII.

FIG. 24 is a perspective view of the optical connection structure illustrated in FIG. 20 from the arrow XXIV.

FIG. 25 is a cross-sectional view along line XXV-XXV indicated by the arrow illustrated in FIG. 20.

### DESCRIPTION OF THE EMBODIMENTS

### First Example

Hereinafter, an optical connection structure according to a first example will be described on the basis of the drawings.

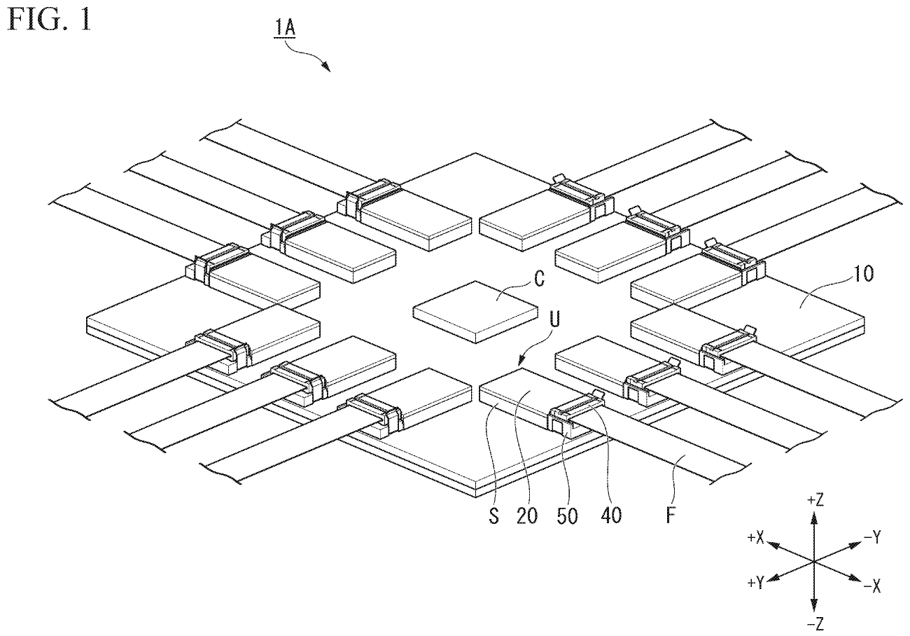

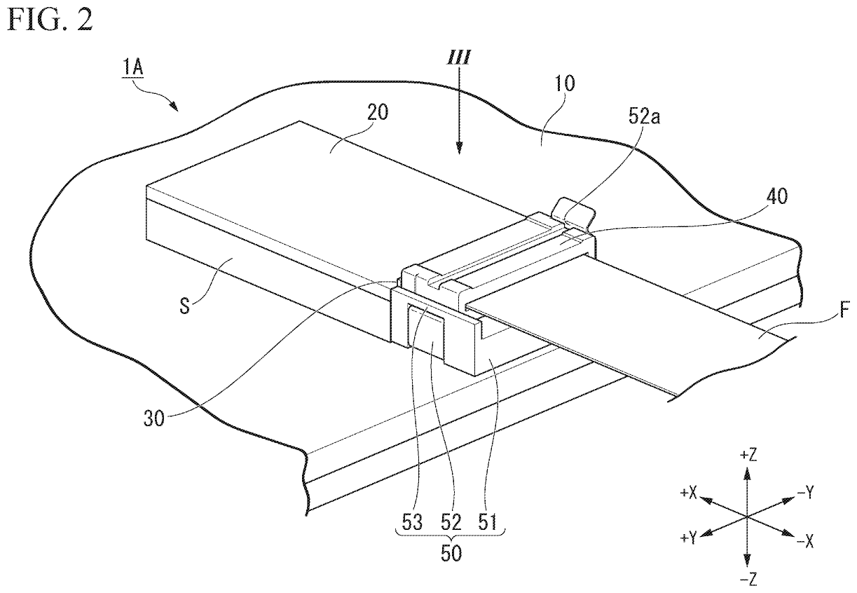

As illustrated in FIGS. 1, 2, and 3, the optical connection structure 1A includes a substrate 10 and a plurality of optical connection units U. The optical connection units U each include an optical integrated circuit 20, a microlens array 30, a ferrule 40, and a receptacle 50. A plurality of fiber holes 41 into which a plurality of optical fibers F are insertable are formed in the ferrule 40. The plurality of fiber holes 41 are arranged in one direction orthogonal to a longitudinal direction of each of the fiber holes 41.

### Definition of Directions

Here, in one or more embodiments, an XYZ orthogonal coordinate system is set to describe a positional relationship of respective components. An X-axis direction is a direction in the longitudinal direction of each fiber hole 41. A Y-axis direction is a direction in which the plurality of fiber holes 41 are arranged. A Z-axis direction is a direction in which the substrate 10 and the optical integrated circuit 20 are arranged. In the present specification, the X-axis direction may be referred to as a longitudinal direction X, a Y-axis direction may be referred to as a first direction Y, and a Z-axis direction may be referred to as a second direction Z. A direction from the ferrule 40 toward the optical integrated circuit 20 in the longitudinal direction X is referred to as a +X direction or a forward direction. A direction opposite to the +X direction is referred to as a −X direction or a rearward direction. One direction in the first direction Y is referred to as a +Y direction or a leftward direction. A direction opposite to the +Y direction is referred to as a −Y direction or a rightward direction. A direction from the substrate 10 toward the optical integrated circuit 20 in the second direction Z is referred to as a +Z direction or an upward direction. A direction opposite to the +Z direction is referred to as a −Z direction or a downward direction.

In one or more embodiments, an electric circuit C and a pattern (not illustrated) are mounted on an upper surface of the substrate 10. The electric circuit C may be, for example, a switch circuit and the like. Also, the plurality of optical connection units U are disposed to surround the electric circuit C.

In one or more embodiments, the optical integrated circuit 20 is formed in a rectangular parallelepiped shape. The optical integrated circuit 20 includes a light receiving element (not illustrated) converting an optical signal into an electrical signal, and a light emitting element (not illustrated) converting an electrical signal into an optical signal. As the light receiving element, a photodetector such as, for example, a photodiode or the like may be used. As the light emitting element, for example, a semiconductor laser, a light emitting diode, or the like may be used.

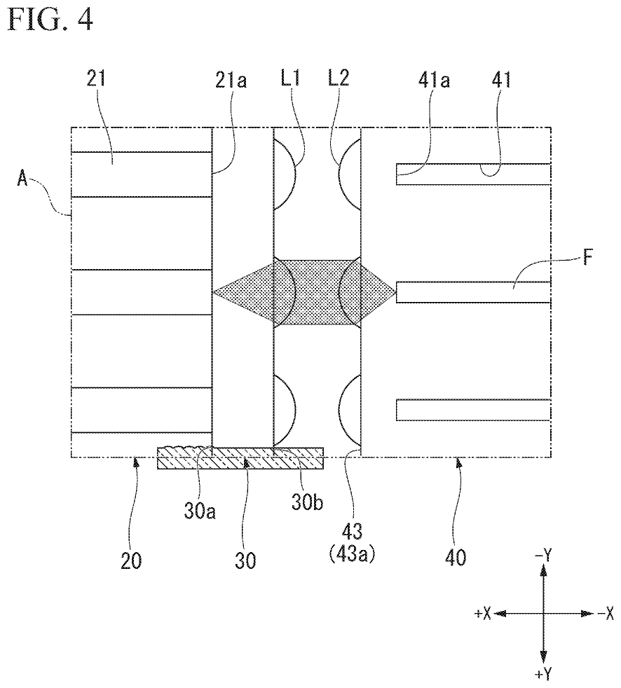

As illustrated in FIG. 4, the optical integrated circuit 20 has a plurality of waveguides 21. Note that, in figures other than FIG. 4, illustration of the waveguides 21 is omitted. The waveguides 21 are each optically connected to the light receiving element and the light emitting element described above. In one or more embodiments, each waveguide 21 extends along the longitudinal direction X. Each waveguide 21 is formed of, for example, silicon. The waveguide 21 has a higher refractive index than a refractive index of a portion other than the waveguide 21 in the optical integrated circuit 20. Thereby, the optical signal is confined inside the waveguide 21, and the optical signal propagates in the longitudinal direction X. The waveguide 21 may be provided on a surface (upper surface) of the optical integrated circuit 20 or may be provided inside the optical integrated circuit 20. A reception/emission portion 21a is provided at a rear end of each waveguide 21. The reception/emission portion 21a is a portion of the waveguide 21, and receives and emits an optical signal.

An optical signal emitted from the optical fiber F is received by the reception/emission portion 21a and propagates through the waveguide 21. Then, the optical signal is converted into an electrical signal by the light receiving element included in the optical integrated circuit 20 and transferred to the substrate 10. Also, the electrical signal transmitted from the substrate 10 to the optical integrated circuit 20 is converted into an optical signal by the light emitting element included in the optical integrated circuit 20. Then, the optical signal propagates through the waveguide 21 to be emitted toward the optical fiber F from the reception/emission portion 21a.

Note that, in one or more embodiments, the optical integrated circuit 20 is electrically connected to the substrate 10 via a socket S. That is, the optical integrated circuit 20 and the substrate 10 transfer an electrical signal therebetween via the socket S. The optical integrated circuit 20 may be removable from the socket S. Note that, the socket S may be replaced with a spacer. In this case, the optical integrated circuit 20 and the substrate 10 may be electrically connected by a wiring (not illustrated). Alternatively, the optical integrated circuit 20 may be directly mounted on the upper surface of the substrate 10.

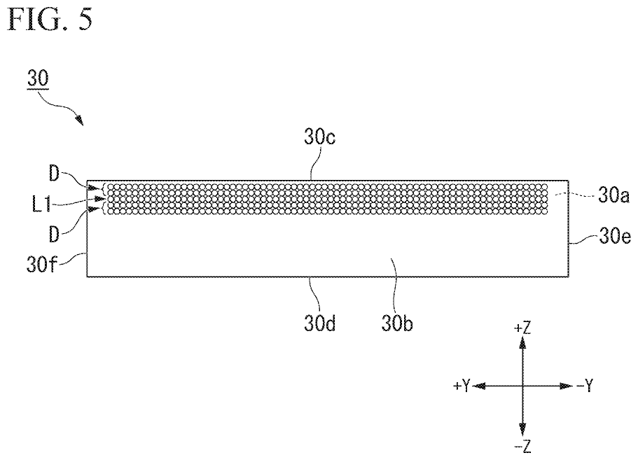

The microlens array 30 is formed of a material that is capable of transmitting light. The microlens array 30 may be formed of, for example, quartz glass or a silicon substrate. As illustrated in FIG. 5, in one or more embodiments, the microlens array 30 has a rectangular plate shape. The microlens array 30 has a front surface 30a, a rear surface 30b, an upper surface 30c, a lower surface 30d, a right surface 30e, and a left surface 30f.

A plurality of first lenses L1 (first lens group L1) and a plurality of dummy lenses D (dummy lens group D) are formed on the rear surface 30b of the microlens array 30. The plurality of first lenses L1 and the plurality of waveguides 21 (reception/emission portions 21a) have a one-to-one correspondence, and the first lenses L1 are respectively aligned with the reception/emission portions 21a in the longitudinal direction X (see also FIG. 4). In one or more embodiments, the optical integrated circuit 20 and the microlens array 30 are fixed so that the optical axes of the first lenses L1 substantially coincides with the respective optical axes of the waveguides 21. Note that, this “substantially coincides” also includes a case in which the two optical axes may be regarded as coincident if manufacturing errors are removed. The same applies to the following description.

The plurality of dummy lenses D are formed on an upper side and a lower side of the plurality of first lenses L1. Note that, the dummy lenses D are not used in propagation of the optical signal.

The optical integrated circuit 20 and the microlens array 30 are fixed with an adhesive. More specifically, the front surface 30a of the microlens array 30 is adhesively fixed to a rear surface of the optical integrated circuit 20 (see also FIG. 4). Since the optical signal passes through a layer of the adhesive, the adhesive is preferably made of a material that transmits light. Note that, in order to adjust propagation characteristics of the optical signal in the adhesive layer, a refractive index of the material used for the adhesive may be adjusted as appropriate. Also, when causing the optical integrated circuit 20 to adhere to the microlens array 30 with an adhesive, they may be adhered while light is incident on the optical integrated circuit 20 or the microlens array 30. In this case, it becomes easier to cause the optical axis of the optical integrated circuit 20 to coincide with the optical axis of the microlens array 30.

The ferrule 40 is attached to the receptacle 50 and is removable from the receptacle 50 (details will be described later). The ferrule 40 has the plurality of fiber holes 41, a fiber insertion hole 42, and a recessed part 43.

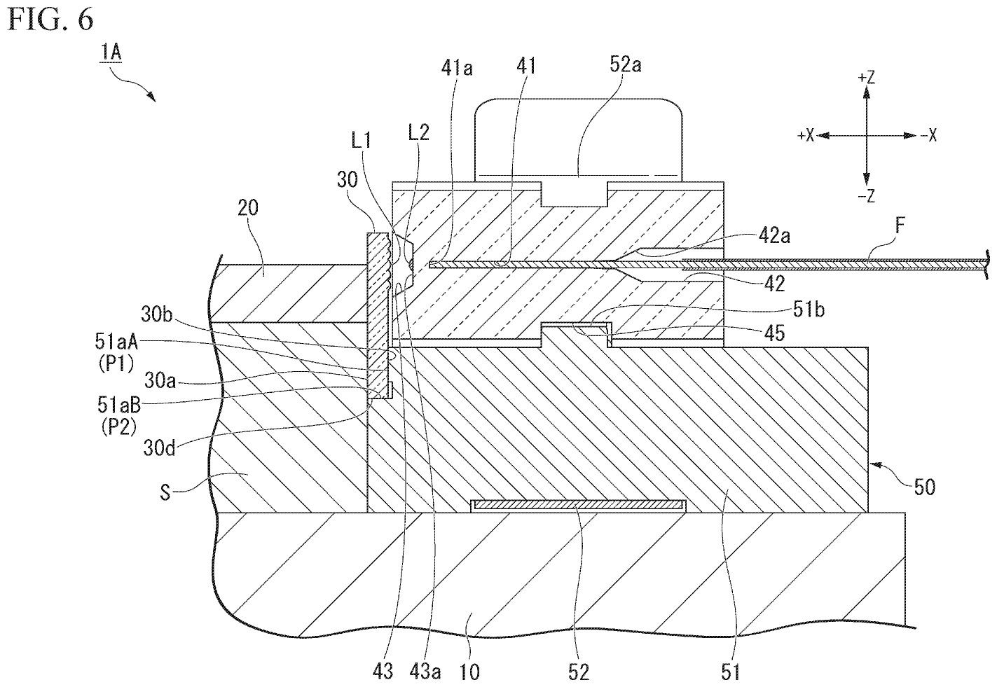

The plurality of fiber holes 41 are arranged in the first direction Y. As illustrated in FIG. 6, each of the fiber holes 41 extends forward from the fiber insertion hole 42. The optical fiber F is inserted into each of the fiber holes 41. More specifically, each of the fiber holes 41 has a distal end 41a, and the optical fiber F is inserted up to the distal end 41a of the fiber hole 41. In one or more embodiments, the fiber hole 41 does not communicate with the recessed part 43. In other words, the distal end 41a of each of the fiber holes 41 is positioned behind a bottom surface 43a (to be described later) of the recessed part 43.

Also, in one or more embodiments, the plurality of optical fibers F are collectively coated to constitute a so-called fiber ribbon. Note that, a configuration of the optical fibers F is not limited thereto, and for example, each optical fiber F may be individually coated.

The fiber insertion hole 42 is a hole recessed forward from a rear surface of the ferrule 40. The fiber insertion hole 42 communicates with the plurality of fiber holes 41. In other words, the fiber holes 41 each open to the fiber insertion hole 42. The fiber insertion hole 42 functions as an entrance when the optical fiber F is inserted into the fiber hole 41. In one or more embodiments, a pair of inclined surfaces 42a are formed on a bottom surface (front surface) of the fiber insertion hole 42. The inclined surfaces 42a are each inclined to gradually approach the fiber hole 41 toward the forward direction. The inclined surface 42a guides the optical fiber F inserted forward from the rear surface of the ferrule 40 to the fiber hole 41. Note that, the ferrule 40 may not have the fiber insertion hole 42 and the inclined surface 42a. In this case, each fiber hole 41 may open at the rear surface of the ferrule 40.

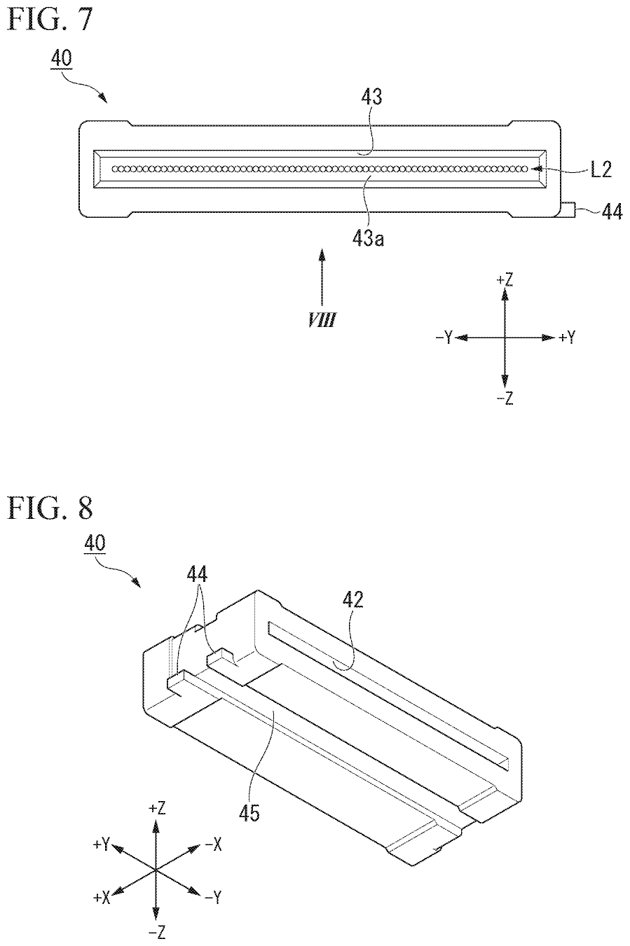

The recessed part 43 is a hole recessed rearward from a front surface of the ferrule 40. The recessed part 43 has the bottom surface 43a facing forward. As illustrated in FIG. 7, a plurality of second lenses L2 are formed on the bottom surface 43a. The plurality of second lenses L2 are arranged in the first direction Y. The plurality of second lenses L2 and the distal ends 41a of the plurality of fiber holes 41 have a one-to-one correspondence, and the second lenses L2 are respectively aligned with the distal ends 41a in the longitudinal direction X (see also FIG. 4). In one or more embodiments, the second lens L2 is disposed so that the optical axes of the second lenses L2 substantially coincide with the respective optical axes of the optical fibers F. Note that, the ferrule 40 may not have the recessed part 43. In this case, the second lens L2 may be provided on the front surface of the ferrule 40.

As illustrated in FIG. 8, in one or more embodiments, the ferrule 40 has an engaging protrusion (engaging part) 44 and a groove (engaging part) 45. The engaging protrusion 44 is a protrusion protruding in the +Y direction (leftward) from a side surface of the ferrule 40. Also, in one or more embodiments, the engaging protrusion 44 is positioned at a center portion of the ferrule 40 in the longitudinal direction X, and is separated into two in the longitudinal direction X. Also, the engaging protrusion 44 is positioned at a lower end portion of the ferrule 40. The groove 45 is recessed upward from a lower surface of the ferrule 40 and extends in the first direction Y. Although details will be described later, the engaging protrusion 44 and the groove 45 engage with an engaging hole (engaged part) 53b and a protrusion (engaged part) 51b included in the receptacle 50, respectively.

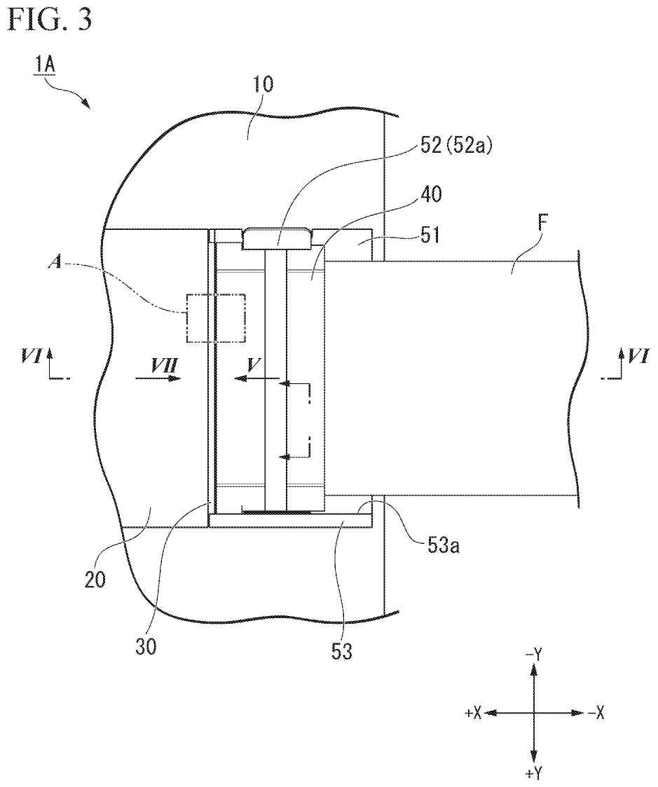

As illustrated in FIGS. 3, 6, and 9, in one or more embodiments, the receptacle 50 includes a main body part 51, an elastic holding part 52, and a wall part 53. The receptacle 50 holds the ferrule 40. More specifically, by the elastic holding part 52 pressing the ferrule 40 against the main body part 51 and the wall part 53, the ferrule 40 is held by the receptacle 50.

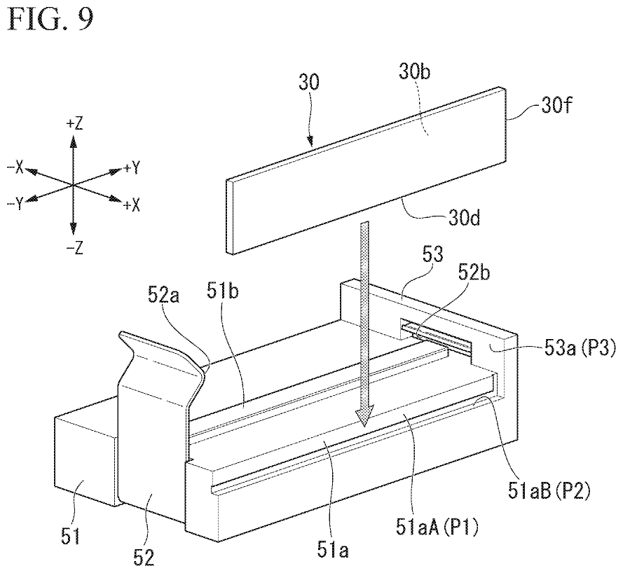

As illustrated in FIGS. 3 and 9, the wall part 53 is erected at a left end of the main body part 51. The wall part 53 is formed in a plate shape extending in the longitudinal direction X and the second direction Z. The wall part 53 has an inner surface 53a facing in the −Y direction (rightward). Note that, the wall part 53 may be erected at a right end of the main body part 51. In this case, the inner surface 53a may face in the +Y direction (leftward). Alternatively, the wall part 53 may be erected at both ends of the main body part 51 in the first direction Y. An engaging hole 53b penetrating the wall part 53 in the first direction Y is formed at a center portion of the wall part 53 in the longitudinal direction X. The engaging hole 53b is positioned at a lower end of the wall part 53.

A recessed part 51a recessed downward from an upper surface of the main body part 51 is formed at a front end of the main body part 51 (see FIGS. 6 and 9). Also, the recessed part 51a opens in the +X direction (forward) and the −Y direction (rightward). Note that, the recessed part 51a may open in the +X direction (forward) and the +Y direction (leftward), or may open only in the +X direction (forward). The recessed part 51a is surrounded by a first surface 51aA facing forward, a second surface 51aB facing upward, and the inner surface 53a of the wall part 53. The first surface 51aA, the second surface 51aB, and the inner surface 53a are also referred to as a first positioning surface P1, a second positioning surface P2, and a third positioning surface P3, respectively.

As illustrated in FIG. 9, when the microlens array 30 is fitted to the recessed part 51a, the receptacle 50 and the microlens array 30 are positioned and adhesively fixed. More specifically, the rear surface 30b of the microlens array 30 is abutted against and adhered to the first positioning surface P1 (the first surface 51aA). Similarly, the lower surface 30d of the microlens array 30 is abutted against and adhered to the second positioning surface P2 (the second surface 51aB). The left surface 30f of the microlens array 30 is abutted against and adhered to the third positioning surface P3 (the inner surface 53a). Note that, the adhesive fixation of the microlens array 30 and the receptacle 50 may be performed after or before the fixation of the microlens array 30 and the optical integrated circuit 20.

The protrusion 51b protruding upward from the upper surface of the main body part 51 and extending in the first direction Y is formed on the main body part 51. A shape of the protrusion 51b corresponds to a shape of the groove 45 included in the ferrule 40.

In one or more embodiments, the elastic holding part 52 is formed in a U shape in a cross-sectional view perpendicular to the longitudinal direction X. The elastic holding part 52 holds the main body part 51. The elastic holding part 52 is formed of an elastically deformable member. The elastic holding part 52 includes a first claw portion 52a and a second claw portion 52b. The second claw portion 52b is inserted into the engaging hole 53b of the wall part 53.

As described above, the receptacle 50 is adhesively fixed to the microlens array 30 via the first surface 51aA, the second surface 51aB, and the inner surface 53a. On the other hand, the receptacle 50 and the substrate 10 are not adhesively fixed. For example, the receptacle 50 and the substrate 10 may be in direct contact. Alternatively, a gel, a sheet, or the like for suppressing relative movement of the receptacle 50 with respect to the substrate 10 may be disposed between the receptacle 50 and the substrate 10.

Next, an operation of the optical connection structure 1A configured as above will be described.

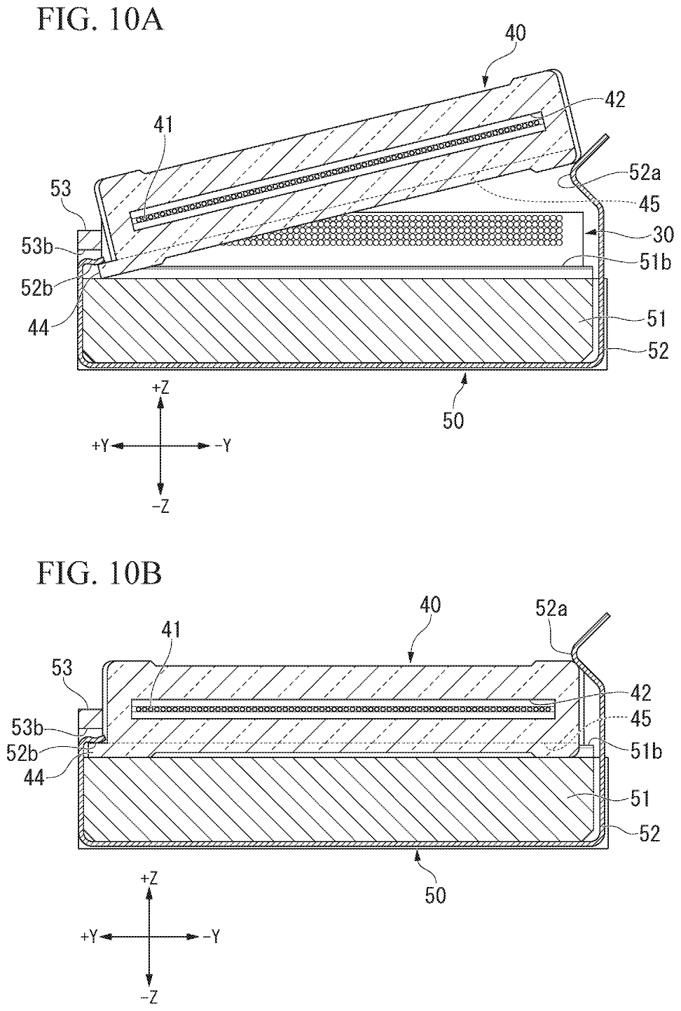

As illustrated in FIG. 10A, when the ferrule 40 is attached to the receptacle 50, firstly, the engaging protrusion (engaging part) 44 of the ferrule 40 is inserted into the engaging hole (engaged part) 53b of the receptacle 50. More specifically, the engaging protrusion 44 is inserted between the second claw portion 52b and the engaging hole 53b. Next, the ferrule 40 is pressed against the receptacle 50 so that the groove (engaging part) 45 of the ferrule 40 and the protrusion (engaged part) 51b of the receptacle 50 are fitted together. At this time, the ferrule 40 displaces the first claw portion 52a toward the right against an elastic restoring force of the elastic holding part 52. When the fitting between the groove 45 of the ferrule 40 and the protrusion 51b of the receptacle 50 is completed, the elastic holding part 52 presses the ferrule 40 toward the main body part 51 and the wall part 53 by the elastic restoring force. Thereby, the ferrule 40 is held by the receptacle 50. Also, since the groove 45 of the ferrule 40 and the protrusion 51b of the receptacle 50 are fitted, relative movement of the ferrule 40 with respect to the receptacle 50 is suppressed.

Note that, when the ferrule 40 is removed from the receptacle 50, the user may, for example, grasp the first claw portion 52a and displace the first claw portion 52a toward the right. Further, the ferrule 40 may be removed from the receptacle 50 by the user lifting the ferrule 40.

As illustrated in FIGS. 3 and 4, when the receptacle 50 holds the ferrule 40, the second lens L2 faces the first lens L1 in the longitudinal direction X. In one or more embodiments, the engaging protrusion 44 engages with the engaging hole 53b, the groove 45 engages with the protrusion 51b, and thereby the ferrule 40 is guided to a position in which the first lens L1 faces the second lens L2. More specifically, the plurality of first lenses L1 and the plurality of second lenses L2 have a one-to-one correspondence, and the first lenses L1 respectively face the second lenses L2 in the longitudinal direction X. In one or more embodiments, when the receptacle 50 holds the ferrule 40, the optical axes of the first lenses L1 substantially coincide with the respective optical axes of the second lenses L2. That is, when the receptacle 50 holds the ferrule 40, the optical axis of the waveguide 21 (the reception/emission portion 21a), the optical axis of the first lens L1, the optical axis of the second lens L2, and the optical axis of the optical fiber F are substantially coincident with each other.

As illustrated in FIG. 4, the optical signal emitted from the optical fiber F is gradually diffused toward the forward direction. The diffused optical signal is shaped into parallel light parallel to the longitudinal direction X by the second lens L2. The optical signal shaped into the parallel light propagates through the air and is focused by the first lens L1. The focused optical signal is received by the reception/emission portion 21a and propagates through the waveguide 21. On the other hand, the optical signal emitted from the reception/emission portion 21a is gradually diffused toward the rearward direction. The diffused optical signal is shaped into parallel light parallel to the longitudinal direction X by the first lens L1. The optical signal shaped into the parallel light propagates through the air and is focused by the second lens L2. The focused optical signal is received by the distal end of the optical fiber F and propagates through the optical fiber F. In this way, according to the optical connection structure 1A in one or more embodiments, it is possible to optically connect the optical integrated circuit 20 and the optical fiber F by attaching the ferrule 40 to the receptacle 50.

Incidentally, a so-called butt joint method in which an optical fiber is brought into contact with an optical integrated circuit for a direct connection is conventionally known. In the butt joint method, a pressing force of about 1 to 2 kgf has been generally required so that the optical fiber and the optical integrated circuit are made to abut each other. However, since the optical integrated circuit is a precision component, there has been cases in which it is does not withstand a high pressing force as described above.

On the other hand, according to the optical connection structure 1A of one or more embodiments, it is possible to optically connect the optical integrated circuit 20 and the optical fiber F without the optical integrated circuit 20 and the optical fiber F being abutted to each other. Therefore, it is possible to reduce a load on the optical integrated circuit 20 compared to, for example, an optical connection structure employing the butt joint method. Thereby, it is possible to prevent the optical integrated circuit 20 from being damaged or falling off from the substrate 10.

Incidentally, generally, there is often a difference between a mode field diameter (MFD) of the optical fiber F and a mode field diameter of the waveguide 21 included in the optical integrated circuit 20. In other words, there is often a mismatch in mode field diameter between the optical fiber F and the waveguide 21. Generally, the mode field diameter of the optical fiber F is about 8.6 μm, whereas the mode field diameter of the waveguide 21 is about 2.0 to 4.0 μm.

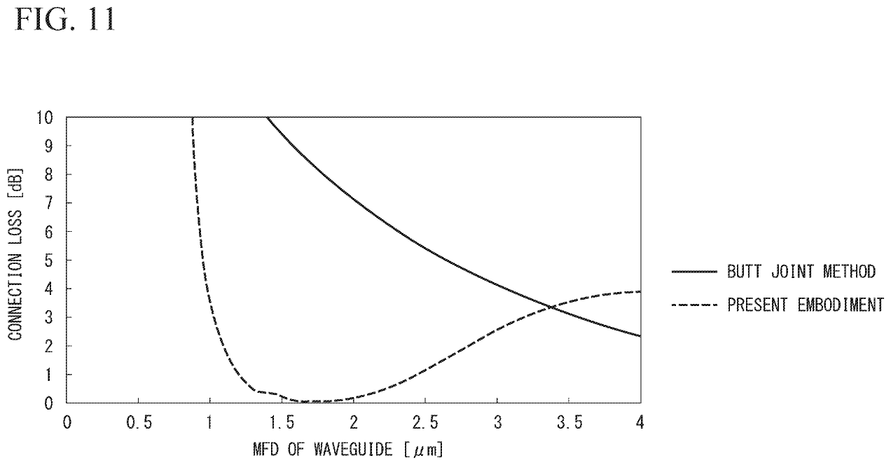

As a result of intensive studies, the inventors of the present application have found that, in the butt joint method, if there is a mismatch (difference) in the mode field diameter as described above between the optical fiber F and the waveguide 21, a connection loss is likely to occur between the optical fiber F and the waveguide 21. FIG. 11 is a graph illustrating results of calculating a connection loss occurring in the optical connection structure in which the butt joint method is employed and a connection loss occurring in the optical connection structure 1A according to one or more embodiments. The horizontal axis represents a mode field diameter of the waveguide 21. The vertical axis represents a magnitude of the connection loss. Note that, the magnitude of the connection loss is calculated assuming that the mode field diameter of the optical fiber F is 8.6 μm.

As illustrated in FIG. 11, for example, when the mode field diameter of the waveguide 21 is 3.0 μm, the connection loss in case of the butt joint method is 4.1 dB, whereas the connection loss of the optical connection structure 1A according to one or more embodiments is 2.6 dB. As described above, it is possible to reduce the connection loss occurring between the optical fiber F and the waveguide 21 by using the optical connection structure 1A according to one or more embodiments.

On the other hand, in the conventional butt joint method, a method for achieving improvement in the connection loss by connecting the optical integrated circuit 20 and the optical fiber F to which a mode field diameter converter (TEC: thermally-diffused expanded core) is fusion-spliced (TEC fusion) is also conceivable. However, since the TEC fusion takes a lot of work time, an increase in the number of fibers (the number of the optical fibers F) may be disadvantageous for mass production.

In contrast, in the optical connection structure 1A according to one or more embodiments, in overcoming a mismatch of the mode field diameter, it is not necessary to fuse the TEC to the optical fiber F. Therefore, even when the number of the optical fibers F incorporated in the optical connection structure 1A increases, it is possible to make an increase in the time required for connecting the optical fibers F and the waveguide 21 less likely to occur.

As described above, the optical connection structure 1A according to one or more embodiments includes the substrate 10, the optical integrated circuit 20 which is electrically connected to the substrate 10 and includes the reception/emission portion 21a configured receiving and emitting an optical signal, the microlens array 30 which includes the first lens L1 disposed at a position corresponding to the reception/emission portion 21a, the ferrule 40 which includes the second lens L2 and the fiber hole 41 into which the optical fiber F inputting an optical signal into the second lens is insertable, and the receptacle 50 which holds the ferrule 40, in which the optical integrated circuit 20 and the receptacle 50 are fixed to the microlens array 30, and the second lens L2 faces the first lens L1 when the receptacle 50 holds the ferrule 40.

According to this configuration, it is possible to optically connect the optical integrated circuit 20 and the optical fiber F by attaching the ferrule 40 to the receptacle 50. Also, it is possible to optically connect the optical integrated circuit 20 and the optical fiber F without the optical integrated circuit 20 and the optical fiber F being abutted to each other. Therefore, it is possible to reduce a load on the optical integrated circuit 20 compared to that in, for example, the optical connection structure employing the butt joint method.

Also, the receptacle 50 has the first positioning surface P1 (the first surface 51aA), the second positioning surface P2 (the second surface 51aB), and the third positioning surface P3 (the inner surface 53a), and the microlens array 30 is abutted against the first positioning surface P1, the second positioning surface P2, and the third positioning surface P3. With this configuration, it is possible to improve an accuracy of positioning the microlens array 30 with respect to the receptacle 50 when the optical connection structure 1A is manufactured.

Also, the ferrule 40 includes the engaging part (the engaging protrusion 44 and the groove 45), the receptacle 50 includes the engaged part (the engaging hole 53b and the protrusion 51b), and the engaging protrusion 44 and the groove 45 engage with the engaging hole 53b and the protrusion 51b to guide the ferrule 40 to a position in which the first lens L1 and the second lens L2 face each other. With this configuration, it is possible to make positioning between the first lens L1 and the second lens L2 easier.

Also, the receptacle 50 includes the elastic holding part 52 that holds the ferrule 40 by an elastic force. With this configuration, it is possible to make hold of the ferrule 40 by the receptacle 50 more stable.

### Second Example

Next, a second example will be described, but a basic configuration is the same as that in the first example. Therefore, components which are the same are denoted by the same reference signs, description thereof will be omitted, and only different points will be described.

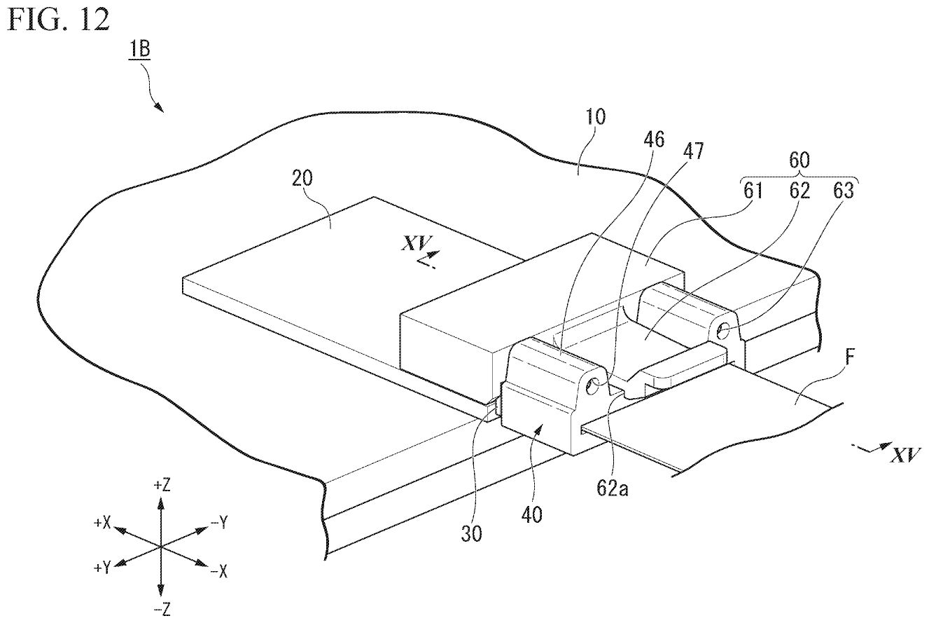

As illustrated in FIG. 12, in an optical connection structure 1B according to the second example, an optical integrated circuit 20 is directly mounted on a substrate 10. Also, the ferrule 40 has a pair of protruding parts 46 and a pair of guide pin holes (engaging parts) 47. Also, a configuration of a receptacle 60 is different from the configuration of the receptacle 50 in the first example.

The protruding parts 46 each protrude upward from an upper surface of the ferrule 40. In one or more embodiments, the pair of protruding parts 46 are disposed at interval in a first direction Y, and are provided at both end portions of the ferrule 40 in the first direction Y. The guide pin holes 47 each penetrate the protruding part 46 in a longitudinal direction X. Although details will be described later, the guide pin hole 47 engages with a guide pin (engaged part) 63 included in the receptacle 60.

The receptacle 60 includes a main body part 61, an elastic protruding part 62, and a pair of guide pins 63. The main body part 61 is adhesively fixed to the optical integrated circuit 20.

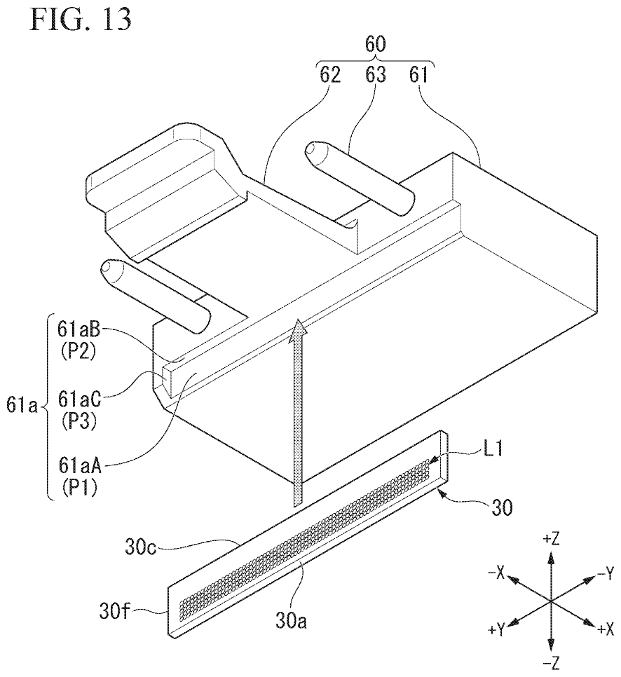

As illustrated in FIG. 13, a recessed part 61a recessed upward from a lower surface of the main body part 61 is formed at a rear end of the main body part 61. The recessed part 61a opens in a −X direction (rearward) and a −Y direction (rightward). Note that, the recessed part 61a may open in the −X direction (rearward) and a +Y direction (leftward), or may open only in the −X direction (rearward). In one or more embodiments, the recessed part 61a is surrounded by a first surface 61aA facing in the −X direction (rearward), a second surface 61aB facing in a −Z direction (downward), and a third surface 61aC facing in the −Y direction (rightward). The first surface 61aA, the second surface 61aB, and the third surface 61aC are also referred to as a first positioning surface P1, a second positioning surface P2, and a third positioning surface P3, respectively.

Also in the second example, as in the first example, a microlens array 30 is fitted to the recessed part 61a, and thereby the receptacle 60 and the microlens array 30 are positioned and adhesively fixed. More specifically, a front surface 30a of the microlens array 30 is abutted against and adhered to the first positioning surface P1 (the first surface 61aA). Similarly, an upper surface 30c of the microlens array 30 is abutted against and adhered to the second positioning surface P2 (the second surface 61aB). A left surface 30f of the microlens array 30 is abutted against and adhered to the third positioning surface P3 (the third surface 61aC). Also, as in the first example, the microlens array 30 is also adhesively fixed to the optical integrated circuit 20.

The elastic protruding part 62 protrudes rearward from a rear surface of the main body part 61. When the ferrule 40 is attached to the receptacle 60, the elastic protruding part 62 is disposed between the pair of protruding parts 46. The elastic protruding part 62 is formed of an elastically deformable member. The elastic protruding part 62 has a claw portion 62a. The guide pins (engaged parts) 63 each protrude rearward from the rear surface of the main body part 61.

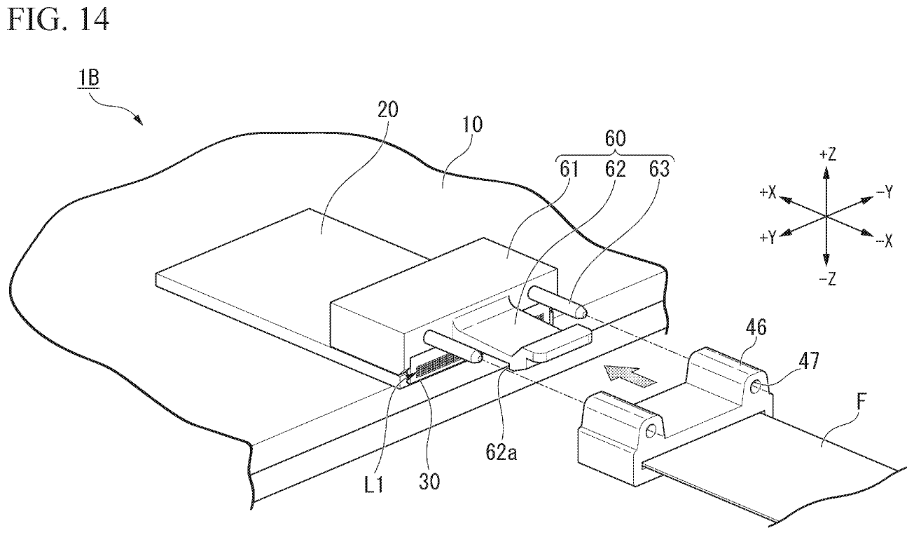

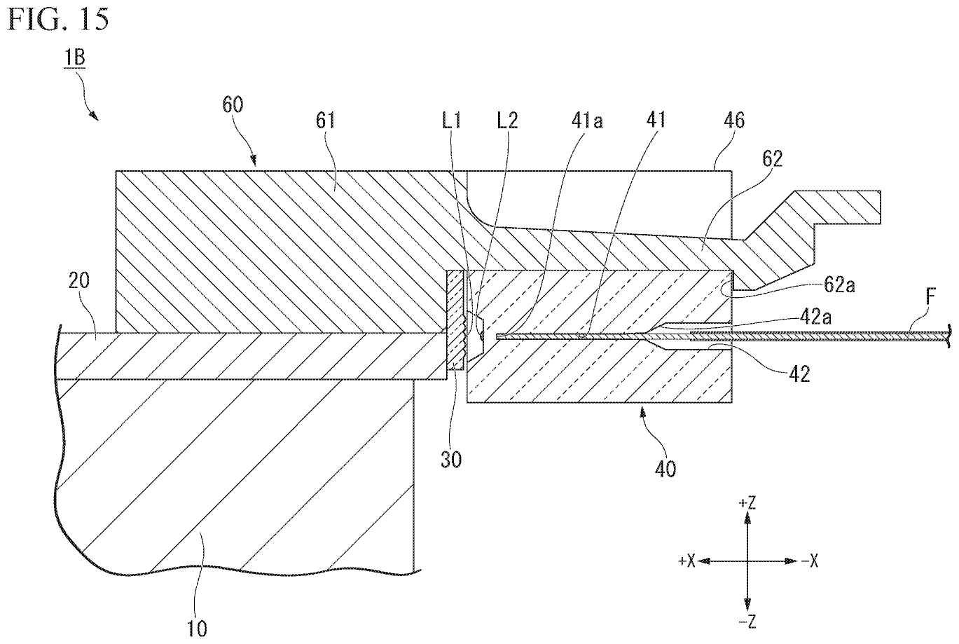

As illustrated in FIG. 14, when the ferrule 40 is attached to the receptacle 60, firstly, the guide pin (engaged part) 63 of the receptacle 60 is inserted into the guide pin hole (engaging part) 47 of the ferrule 40. At this time, the ferrule 40 displaces the claw portion 62a upward against an elastic restoring force of the elastic protruding part 62. As illustrated in FIG. 15, when the ferrule 40 comes into contact with the receptacle 60 and insertion of the guide pin 63 into the guide pin hole 47 is completed, the claw portion 62a is displaced downward and meshed with a rear end of the ferrule 40. Thereby, the ferrule 40 is held by the receptacle 60.

Note that, when the ferrule 40 is removed from the receptacle 60, for example, a user may grasp the claw portion 62a and displace the claw portion 62a upward. Further, the ferrule 40 may be removed from the receptacle 60 by the user pulling out the ferrule 40 rearward.

As described above, also in one or more embodiments, when the guide pin hole (engaging part) 47 engages with the guide pin (engaged part) 63, the ferrule 40 is guided to a position in which the first lens L1 and the second lens L2 face each other. That is, when the receptacle 60 holds the ferrule 40, an optical axis of the waveguide 21, an optical axis of the first lens L1, an optical axis of the second lens L2, and an optical axis of the optical fiber F are substantially coincident with each other.

As described above, in the optical connection structure 1B according to the second example, when the receptacle 60 holds the ferrule 40, the second lens L2 faces the first lens L1 as in the first example. Therefore, by attaching the ferrule 40 to the receptacle 60, it is possible to optically connect the optical integrated circuit 20 and the optical fiber F, and the same operation and effect as in the first example is obtained.

Also, similarly to the above-described embodiments, the receptacle 60 has the first positioning surface P1 (the first surface 61aA), the second positioning surface P2 (the second surface 61aB), and the third positioning surface P3 (the third surface 61aC). The ferrule 40 has the engaging part (the guide pin hole 47), the receptacle 60 has the engaged part (the guide pin 63), and the guide pin hole 47 engages with the guide pin 63 to guide the ferrule 40 to a position in which the first lens L1 and the second lens L2 face each other. Thereby, the same operation and effect as in the first example is obtained.

Also, the receptacle 60 includes the guide pin 63, and the ferrule 40 includes the guide pin hole 47 into which the guide pin 63 is inserted. With this configuration, it is possible to further improve an accuracy of positioning the ferrule 40 with respect to the receptacle 60.

### Third Example

Next, a third example will be described, but a basic configuration is the same as that in the second example. Therefore, components which are the same are denoted by the same reference signs, description thereof will be omitted, and only different points will be described.

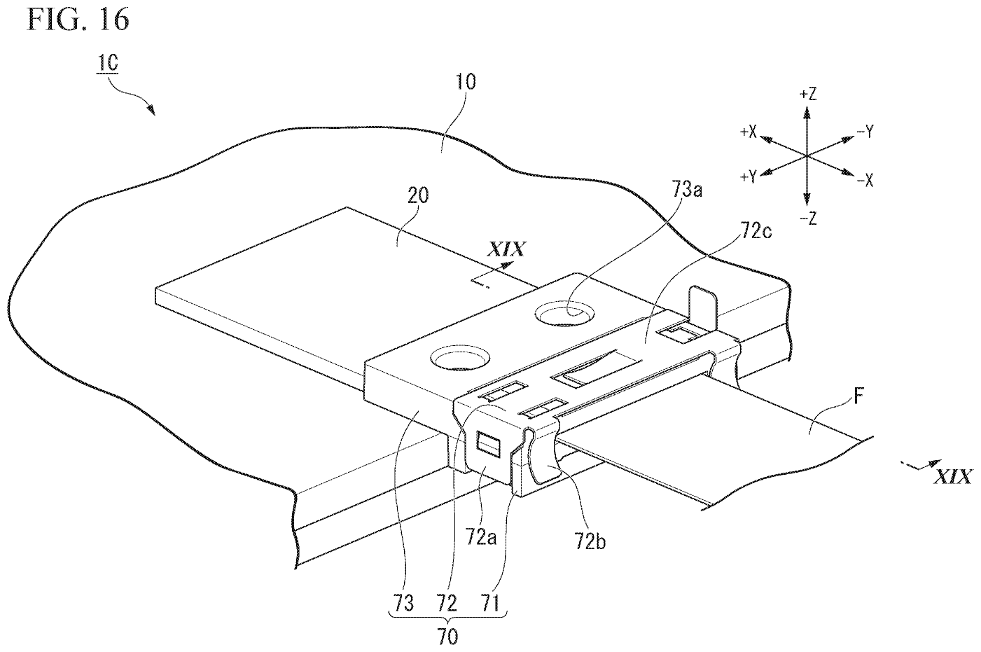

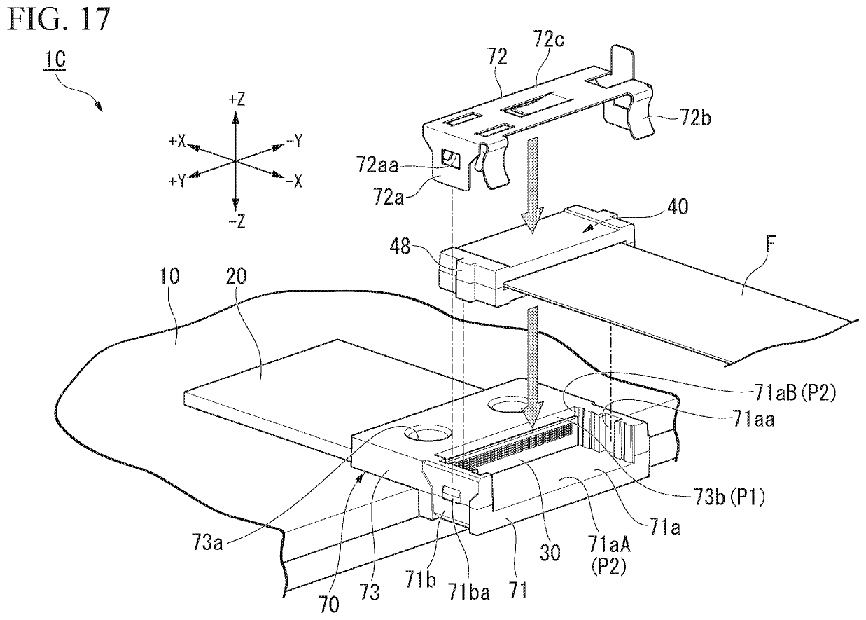

As illustrated in FIGS. 16 and 17, in an optical connection structure 1C according to the third example, a ferrule 40 includes a pair of engaging protrusions (engaging parts) 48. Also, a configuration of the receptacle 70 is different from the configuration of the receptacle 60 in the second example.

As illustrated in FIG. 17, the engaging protrusions 48 each protrude outward in a first direction Y from a side surface of the ferrule 40. In one or more embodiments, the engaging protrusion 48 is positioned at a central portion of the ferrule 40 in a longitudinal direction X. Also, each of the engaging protrusions 48 extends in a second direction Z. Although details will be described later, the engaging protrusion 48 engages with an engaging groove (engaged part) 71aa of the receptacle 70.

The receptacle 70 includes a main body part 71, a lid part 72, and an adhesive part 73. The adhesive part 73 covers an optical integrated circuit 20 from the outside in the first direction Y and the second direction Z, and is adhesively fixed to the optical integrated circuit 20. In one or more embodiments, an adhesive injection window 73a penetrating the adhesive part 73 in the second direction Z is formed in the adhesive part 73. The adhesive injection window 73a is used when an adhesive is injected between the adhesive part 73 and the optical integrated circuit 20. The adhesive part 73 has a rear surface 73b facing rearward. The rear surface 73b of the adhesive part 73 is also referred to as a first positioning surface P1.

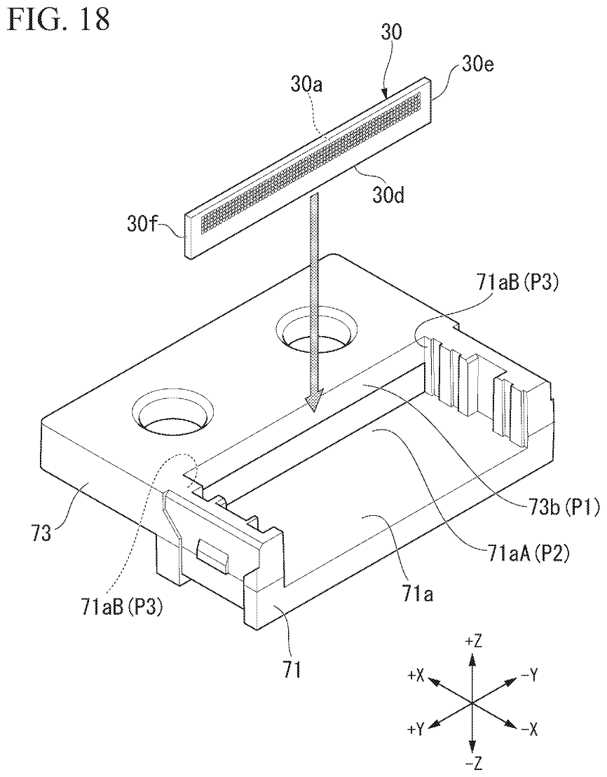

As illustrated in FIGS. 17 and 18, the main body part 71 has a recessed part 71a recessed downward from an upper surface of the main body part 71. The ferrule 40 is accommodated in the recessed part 71a. The recessed part 71a opens rearward. The recessed part 71a has a first surface 71aA facing upward and a pair of second surfaces 71aB facing inward in the first direction Y. The first surface 71aA and the second surface 71aB are also referred to as a second positioning surface P2 and a third positioning surface P3, respectively.

Also in the third example, similarly to the above-described embodiments, a microlens array 30 is fitted to the recessed part 71a, and thereby the receptacle 70 and the microlens array 30 are positioned and adhesively fixed. More specifically, a front surface 30a of the microlens array 30 is abutted against and adhered to the first positioning surface P1 (the rear surface 73b). Similarly, a lower surface 30d of the microlens array 30 is abutted against and adhered to the second positioning surface P2 (the first surface 71aA). A right surface 30e and a left surface 30f of the microlens array 30 are abutted against and adhered to the pair of third positioning surfaces P3 (the second surface 71aB). Also, similarly to the above-described embodiments, the microlens array 30 is also adhesively fixed to the optical integrated circuit 20.

Also, a pair of engaging grooves 71aa are formed in the recessed part 71a. The engaging grooves 71aa are each recessed outward in the first direction Y from the second surface 71aB of the recessed part 71a. In one or more embodiments, the engaging groove 71aa is positioned at a central portion of the recessed part 71a in the longitudinal direction X. Each of the engaging grooves 71aa extends in the second direction Z and opens upward. A shape of the engaging groove 71aa corresponds to a shape of the engaging protrusion 48 included in the ferrule 40.

A pair of fixed grooves 71b recessed inward in the first direction Y from a side surface of the main body part 71 are formed in the main body part 71. Also, a protrusion 71ba protruding outward in the first direction Y from a central portion of each of the fixed grooves 71b is formed in the fixed groove 71b. Although details will be described later, a first fixing part 72a included in the lid part 72 is fitted to the fixed groove 71b, and the protrusion 71ba is fitted to a hole 72aa included in the lid part 72.

The lid part 72 includes a lid part main body 72c, a pair of first fixing parts 72a, and a pair of second fixing parts 72b. When the ferrule 40 is attached to the receptacle 70, the lid part 72 covers an upper surface of the ferrule 40. The lid part main body 72c is formed in a rectangular shape extending in the longitudinal direction X and the first direction Y. The first fixing parts 72a each extend downward from a side surface of the lid part main body 72c. The second fixing parts 72b each extend downward from a rear surface of the lid part main body 72c. The hole 72aa penetrating the first fixing part 72a in the first direction Y is formed in a central portion of the first fixing part 72a. A shape of the hole 72aa corresponds to a shape of the protrusion 71ba included in the main body part 71.

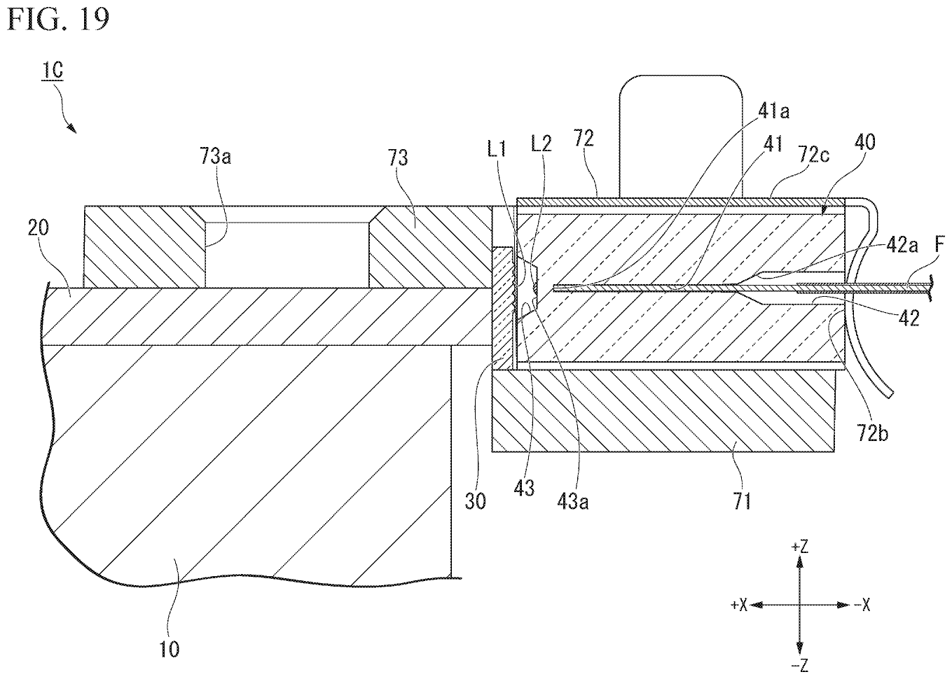

As illustrated in FIG. 17, when the ferrule 40 is attached to the receptacle 70, firstly, the ferrule 40 is inserted into the recessed part 71a from above so that the engaging protrusion (engaging part) 48 of the ferrule 40 is fitted to the engaging groove (engaged part) 71aa of the main body part 71. Next, the lid part 72 is attached to the main body part 71 from above so that the first fixing part 72a of the lid part 72 is fitted to the fixed groove 71b of the main body part 71. When the attachment of the lid part 72 to the main body part 71 is completed, the protrusion 71ba of the main body part 71 and the hole 72aa of the lid part 72 are fitted, and the lid part 72 is fixed to the main body part 71. At this time, the lid part main body 72c of the lid part 72 covers the upper surface of the ferrule 40. Thereby, the ferrule 40 coming out upward from the recessed part 71a is suppressed. Also, since the engaging protrusion 48 of the ferrule 40 and the engaging groove 71aa of the receptacle 70 are fitted, the ferrule 40 shifting in the longitudinal direction X with respect to the receptacle 70 is suppressed. Also, as illustrated in FIG. 19, the second fixing part 72b of the lid part 72 supports a rear surface of the ferrule 40. Thereby, the ferrule 40 shifting in the longitudinal direction X is more reliably suppressed.

As described above, also in one or more embodiments, when the engaging protrusion (engaging part) 48 engages with the engaging groove (engaged part) 71aa, the ferrule 40 is guided to a position in which a first lens L1 and a second lens L2 face each other. That is, when the receptacle 70 holds the ferrule 40, an optical axis of a waveguide 21, an optical axis of the first lens L1, an optical axis of the second lens L2, and an optical axis of an optical fiber F are substantially coincident with each other.

As described above, also in the optical connection structure 1C according to the third example, when the receptacle 70 holds the ferrule 40, the second lens L2 faces the first lens L1 similarly to the above-described embodiments. Therefore, by attaching the ferrule 40 to the receptacle 70, it is possible to optically connect the optical integrated circuit 20 and the optical fiber F, and to obtain the same operation and effect as in the above-described embodiments.

Also, similarly to the above-described embodiments, the receptacle 70 has the first positioning surface P1 (the rear surface 73b), the second positioning surface P2 (the first surface 71aA), and the third positioning surface P3 (the second surface 71aB). The ferrule 40 has the engaging part (the engaging protrusion 48), the receptacle 70 has the engaged part (the engaging groove 71aa), and the engaging protrusion 48 engages with the engaging groove 71aa to guide the ferrule 40 to a position in which the first lens L1 and the second lens L2 face each other. Thereby, the same operation and effect as in the first example is obtained.

Also, the receptacle 70 includes the recessed part 71a in which the ferrule 40 is accommodated, and the lid part 72 covering the ferrule 40 accommodated in the recessed part 71a. With this configuration, it is possible to suppress falling off of the ferrule 40 from the receptacle 70.

### Fourth Example

Next, a fourth example will be described, but a basic configuration is the same as that in the third example. Therefore, components which are the same are denoted by the same reference signs, description thereof will be omitted, and only different points will be described.

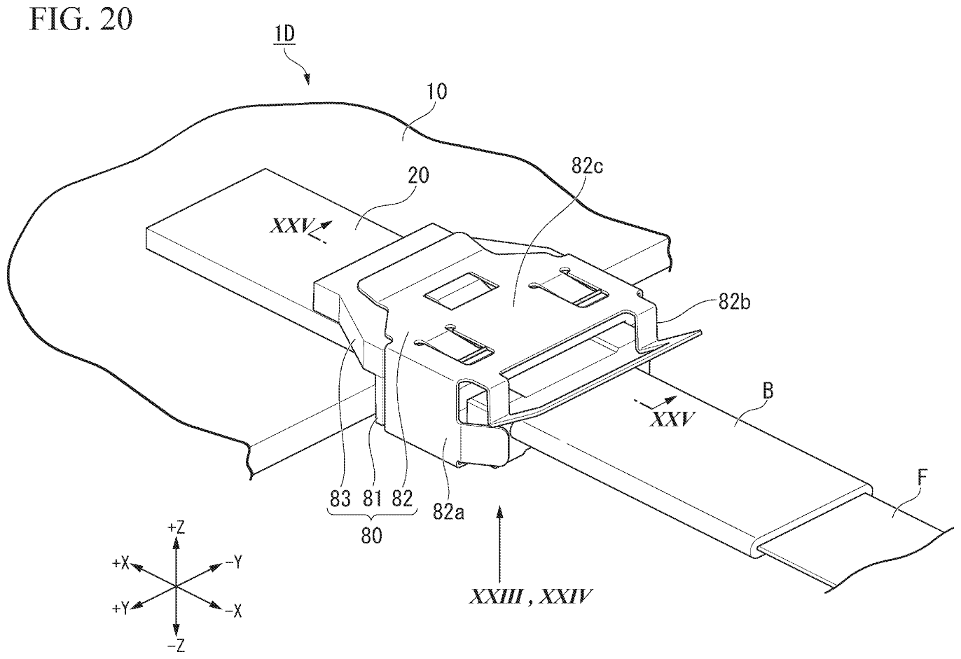

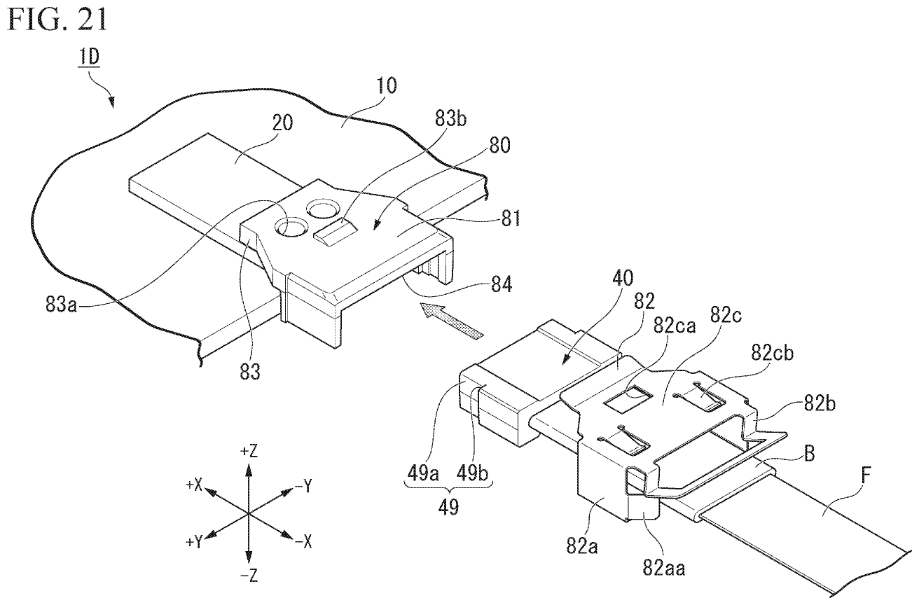

As illustrated in FIGS. 20 and 21, in an optical connection structure 1D according to the fourth example, the ferrule 40 includes a pair of engaging recessed parts (engaging parts) 49. Also, a configuration of a receptacle 80 is different from the configuration of the receptacle 70 in the third example. Also, a boot B is attached to an optical fiber F.

As illustrated in FIG. 21, the engaging recessed parts 49 are each recessed inward in a first direction Y from a side surface of the ferrule 40. Also, each of the engaging recessed parts 49 opens toward the front. The engaging recessed part 49 has a first surface 49a facing outward in the first direction Y and a second surface 49b facing forward. Although details will be described later, the engaging recessed part 49 engages with an engaging protrusion (engaged part) 84a of the receptacle 80.

The receptacle 80 includes a main body part 81, a support part 82, and an adhesive part 83. The adhesive part 83 covers an optical integrated circuit 20 from above and is adhesively fixed to the optical integrated circuit 20. Similar to the third example, an adhesive injection window 83a penetrating the adhesive part 83 in a second direction Z is formed in the adhesive part 83. A protrusion 83b protruding upward from an upper surface of the adhesive part 83 is formed on the adhesive part 83. Although details will be described later, the protrusion 83b is fitted to a hole 82ca included in the support part 82.

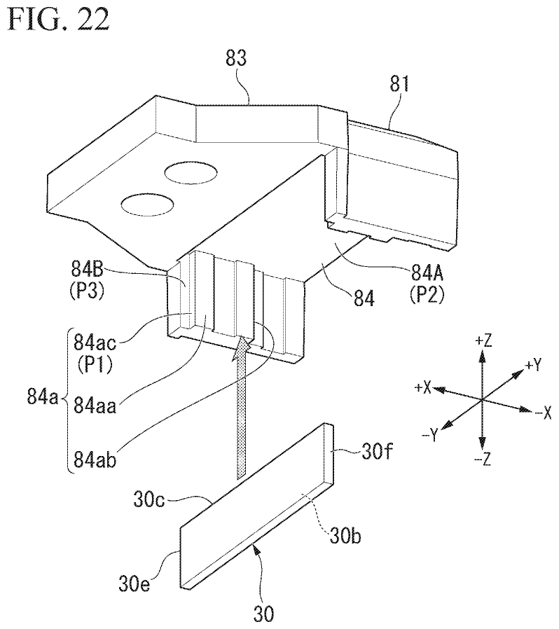

As illustrated in FIGS. 21 and 22, the main body part 81 has a recessed part 84 recessed upward from a lower surface of the main body part 81. The ferrule 40 is accommodated in the recessed part 84. The recessed part 84 opens rearward. As illustrated in FIG. 22, the recessed part 84 has a first surface 84A facing downward and a pair of second surfaces 84B facing inward in the first direction Y. The engaging protrusion 84a protruding inward in the first direction Y is formed on each of the second surface 84B. A shape of the engaging protrusion 84a corresponds to a shape of the engaging recessed part 49 included in the ferrule 40. The engaging protrusion 84a has a protruding surface 84aa facing inward in the first direction Y, a protruding rear surface 84ab facing rearward, and a protruding front surface 84ac facing forward. The protruding front surface 84ac, the first surface 84A, and the second surface 84B are also referred to as a first positioning surface P1, a second positioning surface P2, and a third positioning surface P3, respectively.

Also in the fourth example, similarly to the above-described embodiments, a microlens array 30 is fitted to the recessed part 84, and thereby the receptacle 80 and the microlens array 30 are positioned and adhesively fixed. More specifically, a rear surface 30b of the microlens array 30 is abutted against and adhered to the first positioning surface P1 (the protruding front surface 84ac). Similarly, an upper surface 30c of the microlens array 30 is abutted against and adhered to the second positioning surface P2 (the first surface 84A). A right surface 30e and a left surface 30f of the microlens array 30 are abutted against and adhered to the pair of third positioning surfaces P3 (the second surfaces 84B). Also, similarly to the above-described embodiments, the microlens array 30 is also adhesively fixed to the optical integrated circuit 20.

As illustrated in FIG. 21, the support part 82 includes a support part main body 82c, a pair of first support parts 82a, and a second support part 82b. The support part main body 82c is formed in a plate shape extending in a longitudinal direction X and the first direction Y. The hole 82ca penetrating the support part main body 82c in the second direction Z is formed in the support part main body 82c. A shape of the hole 82ca corresponds to a shape of the protrusion 83b included in the adhesive part 83. Also, the support part main body 82c has a biasing part 82cb. The biasing part 82cb is formed of a material having an elastic force, and biases (pushes) the support part 82 (the support part main body 82c) upward. As the biasing part 82cb, for example, a leaf spring or the like may be employed.

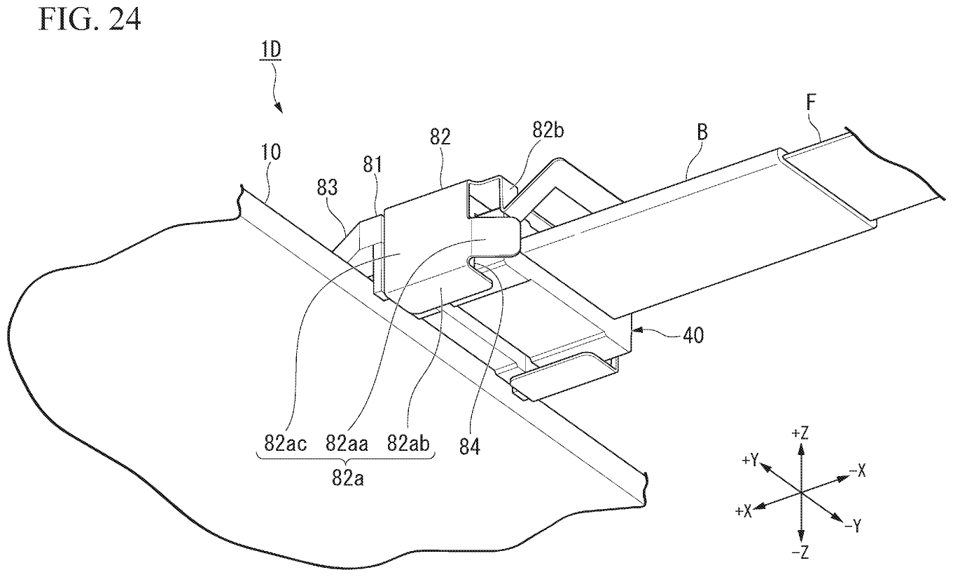

The first support parts 82a each include a base part 82ac, a pressing part 82aa, and a lifting part 82ab (see also FIG. 24). In one or more embodiments, the base part 82ac, the pressing part 82aa, and the lifting part 82ab are each formed in a plate shape. The base part 82ac extends downward from a side surface of the support part main body 82c. The pressing part 82aa extends from a rear surface of the support part main body 82c. In one or more embodiments, the pressing part 82aa is gradually inclined inward in the first direction Y toward the rearward direction (−X direction). The lifting part 82ab extends inward in the first direction Y from a lower end of the support part main body 82c. Each of the second support parts 82b extends downward from a rear surface of the support part main body 82c. As illustrated in the example such as FIG. 20, the second support part 82b may have a handle.

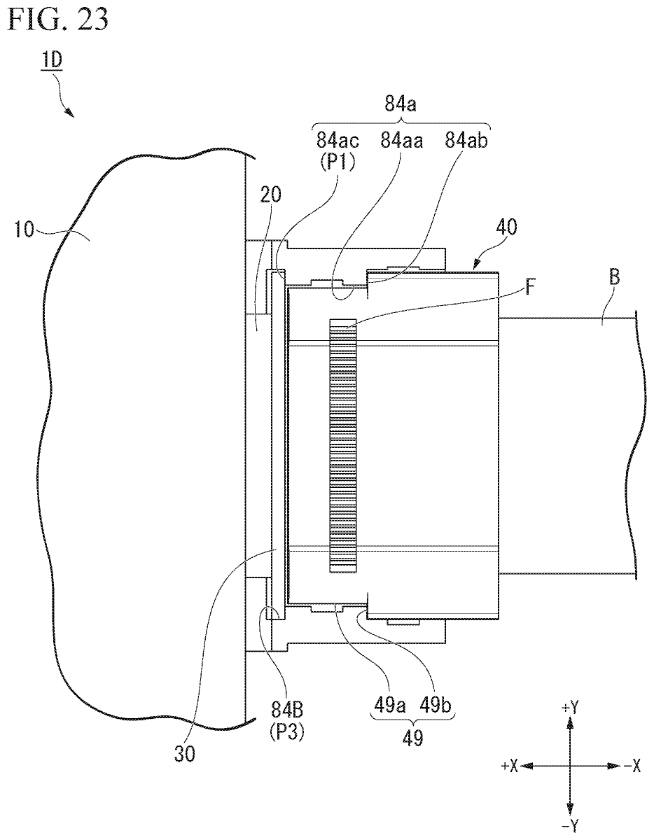

As illustrated in FIGS. 21 and 23, when the ferrule 40 is attached to the receptacle 80, firstly, the ferrule 40 is inserted into the recessed part 84 from the rear so that the engaging recessed part (engaging part) 49 of the ferrule 40 is fitted to the engaging protrusion (engaged part) 84a of the recessed part 84. When the insertion of the ferrule 40 into the recessed part 84 is completed, the second surface 49b of the engaging recessed part 49 comes into contact with the protruding rear surface 84ab of the recessed part 84, and the ferrule 40 is positioned with respect to the recessed part 84.

Next, the support part 82 is attached to the main body part 81 and the adhesive part 83 from the rear so that a lower surface of the support part main body 82c comes into contact with upper surfaces of the main body part 81 and the adhesive part 83, and an upper surface of the lifting part 82ab comes into contact with a lower surface of the ferrule 40.

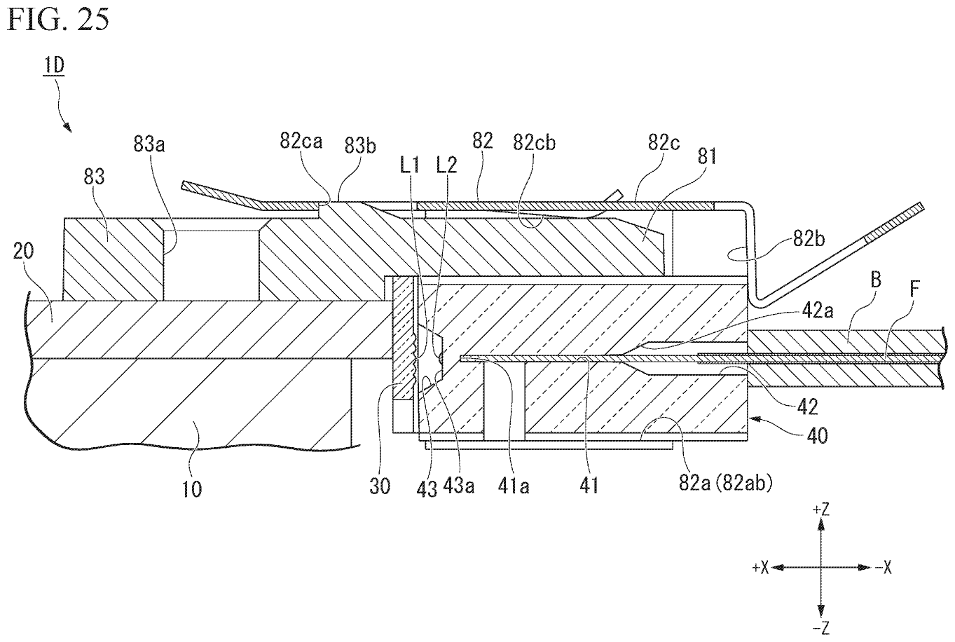

When the attachment of the support part 82 to the main body part 81 and the adhesive part 83 is completed, the protrusion 83b of the adhesive part 83 and the hole 82ca of the support part 82 are fitted, and the support part 82 is fixed to the main body part 81 and the adhesive part 83. At this time, since the biasing part 82cb biases the support part 82 upward, the lifting part 82ab lifts (pushes up) the ferrule 40. Thereby, falling off of the ferrule 40 downward from the recessed part 84 is suppressed. Also, as illustrated in FIGS. 24 and 25, the pressing part 82aa and the second support part 82b of the support part 82 press the ferrule 40 forward. Thereby, the ferrule 40 shifting in the longitudinal direction X is suppressed.

As described above, also in one or more embodiments, when the engaging recessed part (engaging part) 49 engages with the engaging protrusion (engaged part) 84a, the ferrule 40 is guided to a position in which a first lens L1 and a second lens L2 face each other. That is, when the receptacle 80 holds the ferrule 40, an optical axis of a waveguide 21, an optical axis of the first lens L1, an optical axis of the second lens L2, and an optical axis of the optical fiber F are substantially coincident with each other.

As described above, also in the optical connection structure 1D according to the fourth example, when the receptacle 80 holds the ferrule 40, the second lens L2 faces the first lens L1 similarly to the above-described embodiments. Therefore, by attaching the ferrule 40 to the receptacle 80, it is possible to optically connect the optical integrated circuit 20 and the optical fiber F, and to obtain the same operation and effect as in the above-described embodiments.

Also, similarly to the above-described embodiments, the receptacle 80 has the first positioning surface P1 (the protruding front surface 84ac), the second positioning surface P2 (the first surface 84A), and the third positioning surface P3 (the second surface 84B). The ferrule 40 has the engaging part (the engaging recessed part 49), the receptacle 80 has the engaged part (the engaging protrusion 84a), and the engaging recessed part 49 engages with the engaging protrusion 84a to guide the ferrule 40 to a position in which the first lens L1 and the second lens L2 face each other. Thereby, it is possible to obtain the same operation and effect as in the above-described embodiments.

Note that, the technical scope of the present invention is not limited to the above-described embodiments, and various modifications may be made without departing from the gist of the present invention.

For example, in the above-described embodiments, the optical axis of the first lens L1 has been substantially coincident with the optical axis of the second lens L2, but configurations of the first lens L1 and the second lens L2 are not limited thereto. That is, the phrase “the first lens L1 and the second lens L2 face each other” does not necessarily mean that the optical axis of the first lens L1 is substantially coincident with the optical axis of the second lens L2. The optical axis of the first lens L1 and the optical axis of the second lens L2 may be offset from each other or may be inclined as long as it is possible to transfer an optical signal between the first lens L1 and the second lens L2. Alternatively, a distance between the first lens L1 and the second lens L2 in the longitudinal direction X may be changed as appropriate.

Similarly, the phrase “the first lens L1 disposed at a position corresponding to the reception/emission portion 21a” does not necessarily mean that the optical axis of the waveguide 21 is substantially coincident with the optical axis of the first lens L1. The optical axis of the waveguide 21 and the optical axis of the first lens L1 may be offset from each other or may be inclined as long as it is possible to transfer an optical signal between the waveguide 21 and the first lens L1. Alternatively, a distance between the reception/emission portion 21a and the first lens L1 in the longitudinal direction X may be changed as appropriate.

The same applies to a positional relationship between the second lens L2 and the optical fiber F (a fiber hole 41). For example, the first lens L1 may be embedded in a distal end 41a of the fiber hole 41. Alternatively, the first lens L1 may be fused to the optical fiber F.

Also, in the above-described embodiments, it has been described that the optical signal is shaped into parallel light by an action of the first lens L1 or the second lens L2, but the optical signal propagating between the first lens L1 and the second lens L2 may not be parallel to the longitudinal direction X. However, the configuration in which the optical signal is parallel to the longitudinal direction X is preferable because the optical signal is less likely to leak out from between the first lens L1 and the second lens L2.

Also, in the above-described embodiments, the first positioning surface P1, the second positioning surface P2, and the third positioning surface P3 have been respectively perpendicular to the longitudinal direction X, the second direction Z, and the first direction Y, but configurations of the positioning surfaces P1 to P3 are not limited thereto. For example, the positioning surfaces P1 to P3 may not be orthogonal to each other. However, the configuration in which the positioning surfaces P1 to P3 are orthogonal to each other as in the above-described embodiments is preferable because it is easy to suppress a positional deviation and an inclination of the microlens array 30.

Also, in the above-described embodiments, the plurality of first lenses L1 and the plurality of second lenses L2 have had a one-to-one correspondence, but configurations of the first lenses L1 and the second lenses L2 are not limited thereto. For example, the number of first lenses L1 and the number of second lenses L2 may be different. The same applies to the plurality of waveguides 21 and the plurality of first lenses L1. The same applies to the plurality of second lenses L2 and the plurality of fiber holes 41.

Also, the ferrule 40 may not have the plurality of fiber holes 41, but may have only one fiber hole 41. In this case, the optical connection structures 1A to 1D may have only one waveguide 21, first lens L1, and second lens L2.

In addition, the components in the above-described embodiments may be appropriately replaced with well-known components within a range not departing from the gist of the present invention, and the embodiments and modified examples described above may be appropriately combined. Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1A, 1B, 1C, 1D Optical connection structure
10 Substrate
20 Optical integrated circuit
21a Reception/emission portion
30 Microlens array
40 Ferrule
41 Fiber hole
44 Engaging protrusion (engaging part)
45 Groove (engaging part)
47 Guide pin hole (engaging part)
48 Engaging protrusion (engaging part)
49 Engaging recessed part (engaging part)
50 Receptacle
51b Protrusion (engaged part)
52 Elastic holding part
53b Engaging hole (engaged part)
60 Receptacle
63 Guide pin (engaged part)
70 Receptacle
71a Recessed part
71aa Engaging groove (engaged part)
72 Lid part
80 Receptacle
84 Recessed part
84a Engaging protrusion (engaged part)
L1 First lens
L2 Second lens
F Optical fiber
P1 First positioning surface
P2 Second positioning surface
P3 Third positioning surface

1. An optical connection structure, comprising:
a substrate;
an optical integrated circuit, including a reception/emission portion that receives and emits an optical signal, that is electrically connected to the substrate;
a microlens array including a first lens disposed at a position corresponding to the reception/emission portion;
a ferrule including:
a fiber hole into which an optical fiber is inserted; and
a second lens into which an optical signal from the optical fiber is input; and
a receptacle that holds the ferrule, wherein
the optical integrated circuit and the receptacle are fixed to the microlens array, and
the second lens faces the first lens when the receptacle holds the ferrule.

2. The optical connection structure according to claim 1, wherein
the receptacle has a first positioning surface, a second positioning surface, and a third positioning surface, and
the microlens array is abutted against the first positioning surface, the second positioning surface, and the third positioning surface.

3. The optical connection structure according to claim 1, wherein
the receptacle includes an engaged part, and
the ferrule further includes an engaging part that engages with the engaged part and guides the ferrule to a position in which the first lens faces the second lens face.

4. The optical connection structure according to claim 1, wherein the receptacle includes an elastic holding part that holds the ferrule by an elastic force.

5. The optical connection structure according to claim 1, wherein
the receptacle includes a guide pin, and
the ferrule further includes a guide pin hole into which the guide pin is inserted.

6. The optical connection structure according to claim 1, wherein the receptacle includes:
a recessed part in which the ferrule is accommodated, and
a lid part covering the ferrule accommodated in the recessed part.
